(19) United States
(12) Patent Application Publication
(10) Pub. No.: US 2007/0195676 A1
(43) Pub. Date: Aug. 23, 2007

(54) Optical system

(75) Inventors: Robert Frans Maria Hendriks, Eindhoven (NL); Bernardus Hendrikus Wilhelmus Hendriks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,077

(22) PCT Filed: Jan. 13, 2005
(86) PCT No.: PCT/IB05/50150

§ 371 Date: Jul. 11, 2006

(30) Foreign Application Priority Data
Jan. 16, 2004 (EP) 04100125.6

(51) Int. Cl. G11B 7/00

(52) U.S. Cl. 369/112.16; 369/112.02

(57) ABSTRACT

An optical system comprising an optical element arranged on an optical axis in the path of a radiation beam. The optical element (2; 116; 202) comprises a birefringent material and has a non-planar face (4) through which the radiation beam passes. The optical system comprises a polarisation control system for controlling polarisation of the radiation beam such that the radiation beam has a polarisation which is non-uniform across a cross section (21; 24) taken perpendicular to the optical axis, the non-uniform polarisation having a distribution corresponding with a shape of the said non-planar face.

### FIELD OF THE INVENTION

The present invention relates to an optical system, particularly to an optical system for scanning optical record carriers.

### BACKGROUND OF THE INVENTION

In the field of optical recording, information may be stored on an information layer of an optical record carrier such as a compact disc (CD) or a digital versatile disc (DVD). An increase in the density of information which can be stored on such an optical disc can be achieved by decreasing a focal spot size of a radiation beam which is used to scan the optical disc. Such a decrease in spot size may be achieved by using a shorter wavelength of radiation and a higher numerical aperture (NA). In addition to CD and DVD optical discs, and so-called Blu-Ray™ technology which is capable of storing on an optical carrier a higher density of data than a CD or a DVD, the use of Deep Ultraviolet (DUV) radiation is currently being developed to achieve even higher density levels of data storage.

DUV radiation lies in a wavelength region of below approximately 300 nm. Optical systems for recording and mastering data on DUV optical discs require component optical elements of the optical system to provide a high Numerical Aperture (NA) appropriate for DUV radiation, for example NA=0.85 for a DUV radiation wavelength of approximately 256 nm. A high NA is required so that DUV radiation is focused to a spot of sufficient size and quality on a DUV optical disc to accurately scan data on the DUV disc. To achieve this high NA it is necessary to manufacture the optical elements from an appropriate material. However, materials having a refractive index high enough to achieve the desired NA and having sufficiently different optical dispersions to avoid chromatic aberrations, whilst also being isotropic and having an adequate optical transparency, are not commonly available for DUV radiation wavelengths.

Current DUV systems capable of obtaining the high NA needed comprise multiple spherical elements including a Tropel objective lens. Such systems are very expensive and vulnerable to a disruption of their operation by slight positional displacements of the spherical elements.

Various anisotropic materials that have an acceptable optical transparency for DUV radiation wavelengths are birefringent. Additionally, such birefringent materials, for example crystalline materials such as sapphire (Al₂O₃), have suitable refractive indices for obtaining the high NA and suitable optical dispersions for DUV radiation. However, birefringent materials refract a radiation beam differently depending on an orientation of a polarisation component of the radiation beam in relation to an axis of birefringence (“also termed an “optic axis”). For a radiation beam with an arbitrary polarisation, component rays of the beam are differently refracted and consequently different types of rays, termed an ‘ordinary ray’ (o-ray) and an ‘extraordinary ray’ (e-ray) are obtained. Simultaneous occurrence of this difference in refraction of radiation beam component rays within an optical carrier scanning system is undesirable as aberrations of the focal spot reduce the quality of the spot on the optical disc and causing data scanning inaccuracies as a result.

It is an object of the present invention to provide improvements to optical systems using DUV radiation for scanning optical record carriers, especially those comprising optical elements formed of a birefringent material.

### SUMMARY OF THE INVENTION

According to the present invention there is provided an optical system comprising an optical element arranged on an optical axis in the path of a radiation beam, the optical element comprising a birefringent material, the optical element having a non-planar face through which the radiation beam passes, wherein the optical system comprises a polarisation control system for controlling polarisation of the radiation beam such that the radiation beam has a polarisation which is non-uniform across a cross section taken perpendicular to the optical axis, the non-uniform polarisation having a distribution corresponding with a shape of the said non-planar face.

With the radiation beam having a non-uniform polarisation, as controlled by the polarisation control system, the effects of birefringence in the optical element can be reduced. This allows optical elements, for example with a high numerical aperture (NA), to be formed from a birefringent material whilst reducing undesired optical effects of birefringence, such as different refractive effects.

The invention can be applied to the use of birefringent optical elements within an optical scanning device for scanning an optical record carrier, to allow an improved quality of a data signal from, or writing data to, the optical record carrier to be obtained.

Optical elements which display at least some birefringence are cost efficient to manufacture; the invention enables the use of such elements whilst reducing the deleterious effects of birefringence.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a side cross section of an optical element in accordance with an embodiment of the present invention.

FIG. 2 shows a top view of the optical element of the present invention.

FIG. 3 shows a side cross section of the optical element acting upon radiation beams having different non-uniform polarisations.

FIG. 4 shows a cross section of a radiation beam having a non-uniform polarisation in accordance with the present invention.

FIG. 5 shows a cross section of a radiation beam having a different non-uniform polarisation.

FIG. 6 shows schematically a formation of a non-uniform polarisation of a radiation beam.

FIG. 7 shows schematically a radiation beam source for producing a radiation beam having a non-uniform polarisation.

FIG. 8 shows a polarising element of a polarisation control system in accordance with embodiments of the present invention.

FIG. 9 shows a different polarising element of a polarisation control system in accordance with embodiments of the present invention.

FIG. 10 shows a cross section of a radiation beam having a non-uniform polarisation in accordance with an embodiment of the present invention.

FIG. 11 shows schematically components of a polarising system according to an embodiment of the present invention.

FIG. 12 shows schematically relative orientations of liquid crystal elements of a polarising system in accordance with an embodiment of the present invention.

FIGS. 13 and 14 show schematically a change of an initial polarisation to a non-uniform polarisation by a polarising system of the present invention.

FIG. 15a shows a cross section of a radiation beam having a uniform polarisation in accordance with the present invention.

FIG. 15b shows a cross section of a radiation beam having a non-uniform polarisation in accordance with the present invention.

FIG. 15c shows a cross section of a radiation beam having a non-uniform polarisation and a phase modification in accordance with the present invention.

FIG. 16 shows a phase modification element in accordance with an embodiment of the present invention.

FIG. 17 shows schematically an optical system for scanning an optical record carrier in accordance with the present invention.

FIG. 18 shows schematically an operation of optical elements of an optical system in accordance with the present invention.

### DETAILED DESCRIPTION OF THE INVENTION

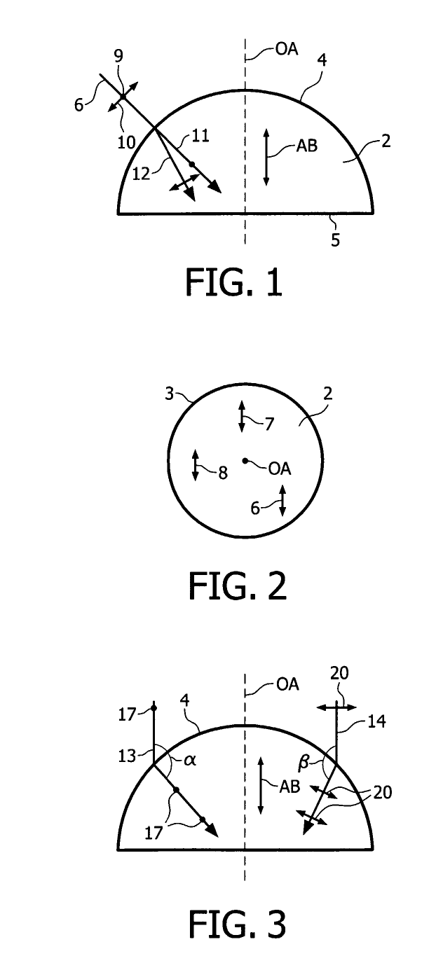

FIG. 1 shows a side cross section of an optical element 2 of an optical system of the present invention. The optical element 2 is arranged on an optical axis OA. In this embodiment the optical element is an optical lens 2 which has a spherical shape centred about the optical axis OA. The optical lens 2 has a non-planar entrance face 4 and a planar exit face 5. The entrance face 4 has a spherical curvature which is rotationally symmetric about the optical axis OA. The optical lens 2 comprises a material which is optically transparent to deep ultraviolet (DUV) radiation having a wavelength of approximately 200-300 nm. In this example the optical lens 2 is formed of crystalline sapphire (chemical formula Al₂O₃) which is birefringent and has a refractive index n of approximately 1.85. The axis of birefringence AB (also called the “optic axis”) is parallel to the optical axis OA.

FIG. 2 shows a top view of the optical lens 2 with a linearly, uniformly polarised DUV radiation beam travelling along the optical axis OA. Three exemplary (first, second and third) component rays 6, 7, 8 of the uniformly polarised radiation beam are shown. Note that each component ray of the radiation beam (which may for example have a planar or spherical wavefront) is differently refracted depending on a specific position at which a component ray strikes and passes through the non-planar face 4.

Referring to FIG. 1 also, the first exemplary component ray 6 (which is representative of most rays in the beam) strikes the entrance face 4 at a specific position such that the linear polarisation of the ray is orientated partially radially and partially tangentially to the circular perimeter 3 of the optical lens 2. The first component ray 6 therefore has both a tangential polarisation component 9 and a radial polarisation component 10 which are perpendicular to each other. The tangential polarisation component 9 is refracted according to the first refractive index n₁ to produce an o-ray 11. The radial polarisation component 10 is refracted according to the second refractive index n₂ to produce an e-ray 12. Therefore the first component ray 6 produces a mixture of an o-ray and an e-ray. The e-ray is produced by a refraction which is not in accordance with Snell's law of refraction.

The second exemplary component ray 7 strikes the entrance face 4 at a specific position such that the linear polarisation of the ray is orientated radially to the circular perimeter 3 of the optical lens 2. This radial orientation results in the second component ray 7 being refracted according to a second refractive index n₂ of the optical lens 2 to produce an extraordinary ray (e-ray). The e-ray has a directional path of propagation which is angularly displaced from the path of propagation of the component ray from which it was produced, in this instance the second component ray 7.

The third exemplary component ray 8 strikes the entrance face 4 at a specific position such that the linear polarisation of the ray is orientated tangentially to a circular perimeter 3 of the optical lens 2. This tangential orientation results in the third component ray 8 being refracted according to a first refractive index n₁ of the optical lens 2 to produce an ordinary ray (o-ray). The o-ray has a directional path of propagation which is coincident with the path of propagation of the component ray from which it was produced, in this instance the third component ray 8.

The radiation beam striking the optical lens 2 has a radiation field. This field may be represented by the following expression:
\vec{E}=E₀\hat{x} (1)
wherein \vec{E} is the radiation field, E₀ is an amplitude of the radiation field, and \hat{x} is a unit vector in a direction coincident with a polarisation of the radiation field.

FIG. 3 shows schematically a side cross section of the optical element 2 acting upon a fourth exemplary component ray 13 and a fifth exemplary component ray 14 of different DUV radiation beams travelling along the optical axis OA. For convenience reasons only, the fourth and the fifth component ray 13, 14 are illustrated by the same figure.

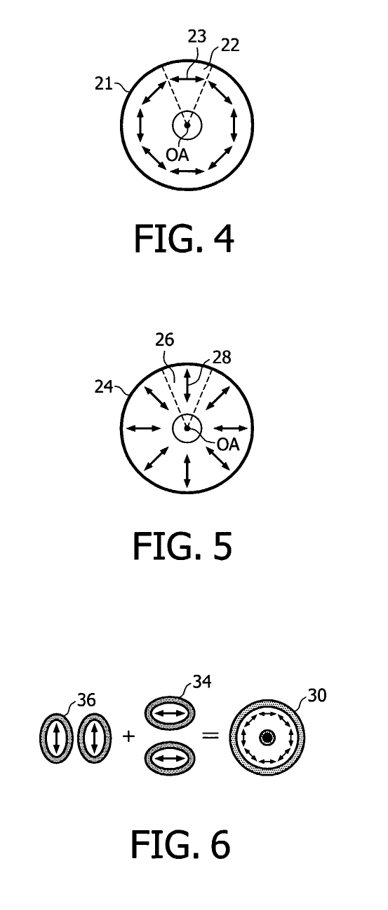

FIG. 4 shows a cross section of a DUV radiation beam having a non-uniform polarisation in accordance with an embodiment of the present invention. In this example the non-uniform polarisation is a substantially tangential polarisation. The radiation beam travelling along an optical axis OA has a circular cross section 21 taken perpendicular the optical axis OA. The tangential distribution of polarisation is non-uniform across the cross section 21 and corresponds with the spherical shape of the optical lens 2. The cross section 21 can be divided into a plurality of sectors 22, indicated in FIG. 4. The tangential polarisation of the radiation beam comprises in each such sector 22 a tangential polarisation component 23. Different of the tangential polarisation components 23 are aligned in a different direction in at least some of said sectors 22. In a complete rotation about the optical axis OA the radiation beam has a substantially tangential form throughout which is rotationally symmetric about the optical axis OA. By a substantially tangential polarisation it is meant that each tangential polarisation component 23 is approximately tangential to a circle centred on the optical axis OA.

Referring again to FIG. 3, a radiation beam travelling along the optical axis OA and having a substantially tangential polarisation similar to that illustrated using FIG. 4 comprises the fourth exemplary component ray 13. The fourth exemplary component ray 13 strikes the entrance face 4 of the optical element 2 at an angle which is not perpendicular to the entrance face 4. The optical element 2, due to the tangential polarisation of the radiation beam, refracts the fourth exemplary component ray 13 according to the first refractive index n₁ by a first refraction angle α. A tangential direction of polarisation 17 of the fourth exemplary component ray 13 lies in a plane which is perpendicular to the optic axis AB. This determines that the refracted fourth exemplary component ray 13 is substantially purely an o-ray and that no, or at least a reduced amount of, e-ray component is produced.

FIG. 5 shows a cross section of a radiation beam having a different non-uniform polarisation, in accordance with a different embodiment of the present invention. In this example the non-uniform polarisation is a substantially radial polarisation. The radiation beam travelling along an optical axis OA has a circular cross section 24 taken perpendicular the optical axis OA. The radial distribution of polarisation is non-uniform across the cross section 24 and corresponds with the spherical shape of the optical lens 2. The cross section 24 can be divided into a plurality of sectors 26, indicated in FIG. 5. The radial polarisation of the radiation beam comprises in each such sector 26 a radial polarisation component 28. Different of the radial polarisation components 28 are aligned in a different direction in at least some of said sectors 26. In a complete rotation about the optical axis OA the radiation beam has a substantially radial form throughout which is rotationally symmetric about the optical axis OA. By a substantially radial polarisation it is meant that each radial polarisation component 28 is approximately coincident with a radius of a circle centred on the optical axis OA.

Referring again to FIG. 3, a different radiation beam travelling along the optical axis OA and having a substantially radial polarisation similar to that illustrated using FIG. 5 comprises the fifth exemplary component ray 14. The fifth exemplary component ray 14 strikes the entrance face 4 of the optical element 2 at an angle which is not perpendicular to the entrance face 4. The optical element 2, due to the radial polarisation, refracts the fifth exemplary component ray 14 according to the second refractive index n₂ by a second refraction angle β. A radial direction of polarisation 20 of the fifth exemplary component ray 14 lies in a plane which is substantially coincident with the optic axis AB and the direction of travel of the ray within the optical element 2. This determines that the refracted fifth exemplary component ray 14 is substantially purely an e-ray and that no, or at least a reduced amount of, o-ray component is produced. This e-ray is produced by a refraction which is not in accordance with Snell's Law of refraction.

FIG. 6 shows schematically the formation of a radiation beam having a tangential polarisation 30.

A radiation beam having a non-uniform polarisation can be formed using different transverse modes (TEM) of the radiation beam. Expression (2) represents a TEM₀₁ Laguerre-Gaussian mode which can be considered to be a sum of a horizontally polarised TEM₀₁ mode 34 and a vertically polarised TEM₁₀ Hermite-Gaussian mode 36.

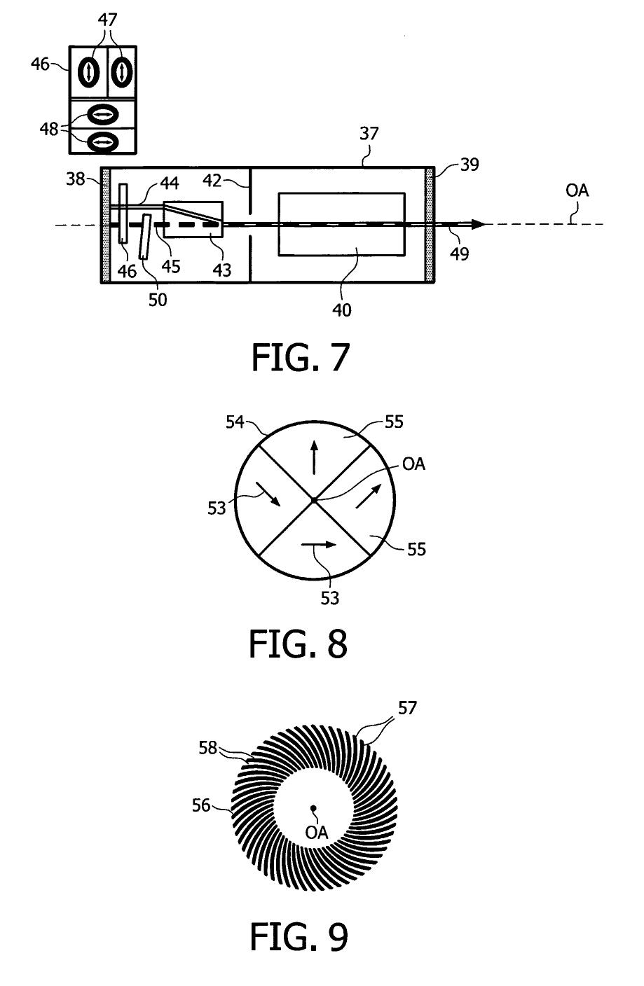

FIGS. 7 to 14 illustrate various alternative polarisation control systems for producing a polarisation distribution in accordance with embodiments of the present invention. The polarisation control system in each case controls a polarisation of a radiation beam such that the radiation beam has a tangential polarisation. For all embodiments of the present invention described, the radiation beam has a wavelength within the range of approximately 200-300 nm.

FIG. 7 shows schematically a radiation beam source 37 which may be used in an embodiment of the invention, using the scheme illustrated in FIG. 6 for producing a radiation beam having a non-uniform polarisation. The Figure, and the following description, is based on the reference: “The formation of laser beams with pure azimuthal or radial polarisation,” R. Oron, S. Blit, N. Davidson, A. A. Friesem, Appl. Phys. Lett. 77(21) (2000).

The radiation beam source 37 comprises a laser cavity with a back mirror 38 and a front mirror 39 which is an output coupler for the radiation beam. The front mirror 39 has a predetermined optical transparency for a particular wavelength of radiation. A gain medium 40 generates radiation of a particular wavelength. This radiation is reflected by the front mirror 39 and travels along an optical axis OA and through an aperture 42 which produces an aligned beam of radiation. The aligned beam of radiation has an arbitrary polarisation which is modified by a birefringent beam displacer 43.

The birefringent beam displacer 43 splits the aligned radiation beam into a radiation beam having a vertical linear polarisation 44 and a radiation beam having a horizontal linear polarisation 45. A direction of travel of the radiation beam having the vertical linear polarisation 44 is angularly displaced from the optical axis OA. A combined discontinuous phase element 46 modifies the horizontally and the vertically linear polarised radiation beams 44, 45.

The combined phase element 46 comprises a first discontinuous phase element which introduces a vertically polarised TEM₁₀ Hermite-Gaussian mode 47 into the radiation beam having the vertical polarisation. The combined phase element 46 further comprises a second discontinuous phase element which introduces a horizontally polarised TEM₀₁ mode 48 into the radiation beam having the horizontal polarisation. Both the introduced TEM modes 47, 48 are similar to those described using FIG. 6 for formation of the tangentially polarised radiation beam.

The back mirror 38 reflects both the radiation beam with the vertically polarised TEM₁₀ Hermite-Gaussian mode 47 and the radiation beam with the horizontally polarised TEM₀₁ mode 48 back towards the birefringent beam displacer 43 which re-combines the polarised radiation beams 47, 48 to form a radiation beam having a substantially tangential polarisation 49. As there is a difference between an optical path length in the birefringent beam displacer of the radiation beam with the vertically polarised TEM₁₀ Hermite-Gaussian mode 47 and of the radiation beam with the horizontally polarised TEM₀₁ mode 48, an alignment plate 50 is positioned between the back mirror 38 and the birefringent beam displacer 43 which compensates for this difference in optical path length. The substantially tangentially polarised beam 49 is then emitted along the optical axis OA by the radiation beam source 37 by travelling through the front mirror 39.

FIG. 8 shows an alternative polarisation control system in accordance with a further embodiment of the invention. In this embodiment the polarisation control system comprises a first polarising element which is a half-wave plate 54 and which is arranged along the optical axis OA. The half-wave plate 54 is centred about the optical axis OA and comprises a plurality of different sections 55. Each section 55 is approximately in the form of a sector 55 about the optical axis OA and is arranged to differently modify a polarisation of the radiation beam travelling along the optical axis OA. Preferably there are at least four radial sectors 55, each sector being an equal proportion of the half wave plate 54. Each sector 55 has an axis of polarisation 53 with a different orientation. In this embodiment there are four sectors 55.

The radiation beam in this embodiment is initially uniformly polarised and has a linear polarisation with a horizontal orientation. The half-wave plate 54 is arranged in the optical system such that the axes of polarisation 53 differently modify regions of the horizontal and linear, uniform polarisation of the radiation beam to form a substantially tangential, non-uniformly polarised radiation beam.

FIG. 9 shows an alternative polarisation control system in accordance with a yet further embodiment of the present invention. In this embodiment a polarising element is used which includes a sub wavelength grating 56. The grating 56 comprises a plurality of alternate curved metal strips 57 and slits 58 arranged approximately radially about the optical axis OA. The metal strips 57 and the slits 58 are curved within a plane of the sub-wavelength grating 56 which is perpendicular the optical axis OA. A width of each metal strip 57 and each slit 58 is less than the wavelength of the radiation beam, the width being taken in a direction perpendicular a radius from the optical axis OA. In this embodiment the radiation beam initially has a circular, uniform polarisation which is modified to a substantially tangential, non-uniform polarisation by the sub-wavelength grating 56.

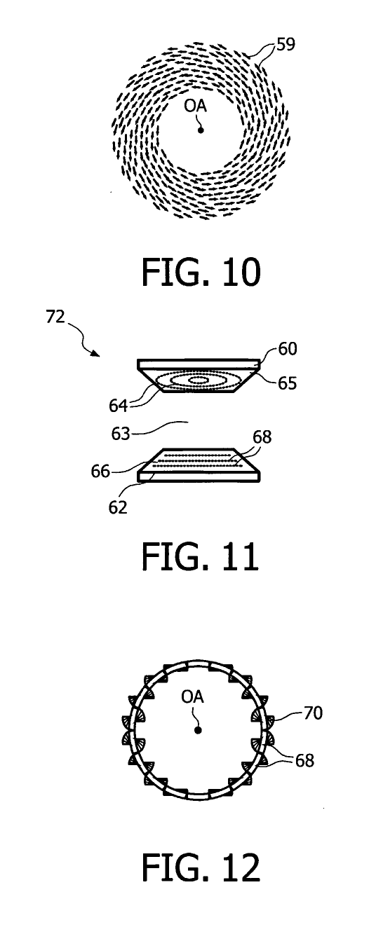

FIG. 10 shows in cross section the modified radiation beam produced using the polarising element of FIG. 9, having a tangential, non-uniform polarisation. The orientations of tangential polarisation components of the tangential polarisation are indicated by arrows 59 about the optical axis OA in FIG. 10. Further information regarding the use of such sub-wavelength gratings to produce non-uniformly polarised radiation beams is included herein by way of the reference: “Pancharatnam-Berry phase in space-variant polarisation-state manipulations with subwavelength gratings,” Ze'ev Bomzon, V. Keiner, E. Hasman, Opt. Lett. 26(18) (2001).

In a further embodiment of the invention, the polarisation control system comprises a first polarising element and a second polarising element. The first polarising element is a half-wave plate similar to the half-wave plate 54 of a previous embodiment and the second polarising element is a sub-wavelength grating similar to the sub-wavelength grating 56 of a previous embodiment; corresponding descriptions of features of this similar half-wave plate and grating should be taken to apply here also. In this embodiment the half wave plate is arranged to change the circular, uniform polarisation to an intermediate polarisation. The intermediate polarisation of the radiation beam comprises both horizontal and vertical polarisation components which have an approximately similar distribution to that of the tangential polarisation components of a substantially tangential, non-uniform polarised radiation beam. The sub-wavelength grating is arranged to change the intermediate polarisation to a substantially tangential, non-uniform polarisation of the radiation beam. An intensity of this radiation beam having the tangential polarisation is approximately 50% greater than an intensity of the tangentially polarised radiation beam produced by the sub-wavelength grating 56 of the previous embodiment.

FIG. 11 shows schematically components of a polarisation control system according to a yet further embodiment of the present invention. In this embodiment the polarisation control system comprises an array of linear liquid crystal elements. The polarising system is a liquid crystal cell 72 which is resistant and optically transparent to ultraviolet radiation, in particular for example, the radiation beam. The liquid crystal cell 72 comprises a first and a second, different, alignment plate 60, 62 respectively. The first and the second alignment plates 60, 62 are aligned with each other along the optical axis OA and are separated from each other by a predetermined space 63. The array of liquid crystal elements fills this space 63 and lies in contact with an inner surface 65 of the first plate 60 and an inner surface 66 of the second plate 62. The first alignment plate 60 is arranged so that the linear liquid crystal elements in contact with its inner surface 65 align to form a series of concentric circles 64. The second alignment plate 62 is arranged so that the linear liquid crystal elements in contact with its inner surface 66 align to form a series of parallel lines 68.

FIG. 12 shows schematically relative orientations of the liquid crystal elements of the liquid crystal cell 72. The liquid crystal elements have a configuration of different radial and/or axial orientations. The liquid crystal cell is arranged on the optical axis OA which runs through a centre of the first and the second alignment plates 60, 62. FIG. 12 is a schematic view looking along the optical axis OA from the inner surface 65 of the first alignment plate 60 to the inner surface 66 of the second alignment plate 62. The second alignment plate 62 is arranged so that the parallel lines 68 are horizontal. As described, the liquid crystal elements are arranged on the inner surface 65 of the first alignment plate 60 to form concentric circles 64, an outermost one of which is shown in FIG. 12. Along a direction parallel the optical axis OA, the liquid crystal elements have different radial orientations such that there is a smooth rotational transition 70 of the liquid crystal elements from the alignment with concentric circles 64 to that of the parallel lines 68.

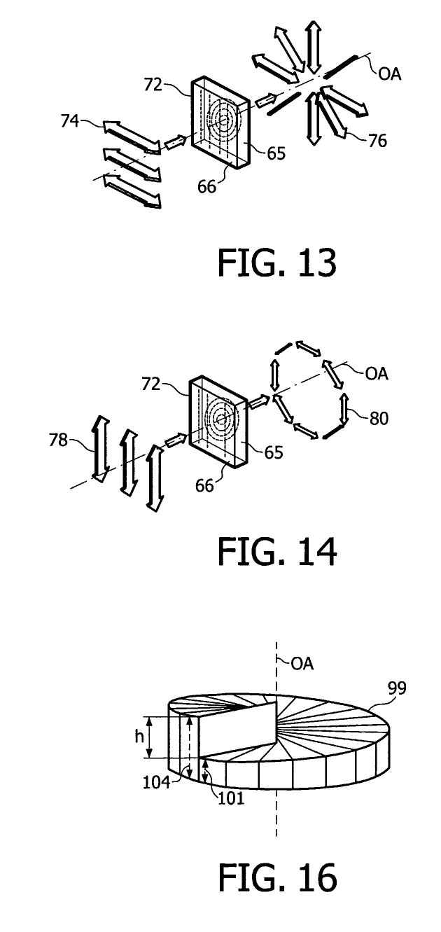

FIGS. 13 and 14 show schematically a change of an initial polarisation of the radiation beam to a non-uniform polarisation performed by the liquid crystal cell 72, arranged as described earlier.

In FIG. 13 the radiation beam has an initial polarisation which is a horizontally linear, uniform polarisation 74. The radiation beam travels along the optical axis OA and the liquid crystal cell 72 changes the horizontally linear polarisation 74 to a non-uniform polarisation, which in this example is a substantially radial polarisation 76. The liquid crystal cell 72 is arranged such that the parallel lines 78 are vertical and that the radiation beam strikes the parallel lines 78 of the second alignment plate 66 before striking the concentric circles 64 of the first alignment sheet 60. The array of liquid crystal elements having the smooth rotational transition between the first and second alignment plates 60, 62 cause the horizontal orientation of the linear polarisation of different regions of the radiation beam to be rotated.

In FIG. 14 the radiation beam has an initial polarisation which is a vertically linear and uniform polarisation 78. The radiation beam travels along the optical axis OA and the liquid crystal cell 72 changes the vertically linear polarisation 78 to a non-uniform polarisation, which in this example is a substantially tangential polarisation 80. The liquid crystal cell 72 is arranged such that the parallel lines 78 are vertical and that the radiation beam strikes the parallel lines 78 of the second alignment plate 66 before striking the concentric circles 64 of the first alignment sheet 60. The array of liquid crystal elements having the smooth rotational transition between the first and second alignment plates 60, 62 cause the vertical orientation of the linear polarisation of different regions of the radiation beam to be rotated. Further information on the changing of a polarisation of a radiation beam by a liquid-crystal array is included herein by way of the reference: “Linearly polarised light with axial symmetry generated by liquid-crystal polarisation converters,” M. Stalder, M. Schadt, Opt. Lett. 21(23) (1996).

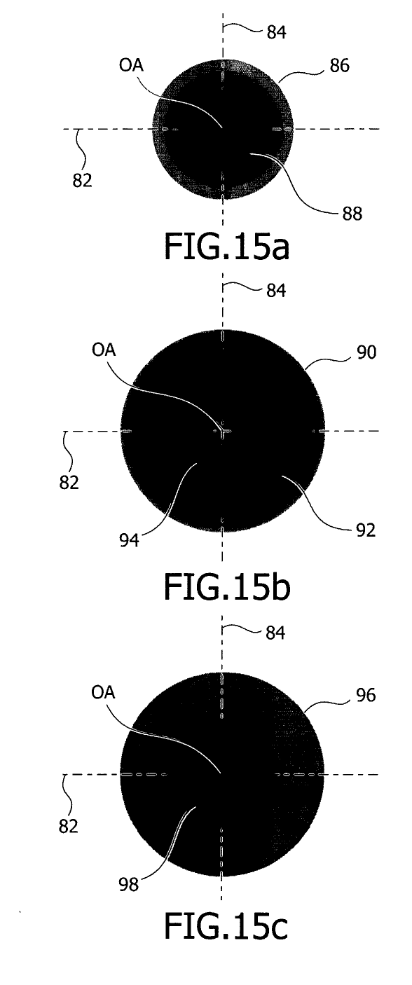

FIG. 15a shows a cross section of a radiation beam having a uniform polarisation in accordance with the present invention.

FIG. 15b shows a cross section of a radiation beam having a non-uniform polarisation in accordance with the present invention.

FIG. 15c shows a cross section of a radiation beam having a non-uniform polarisation with a phase modification in accordance with the present invention.

For all of FIGS. 15a-15c the radiation beam is travelling along an optical axis OA which lies at the centre of the cross section of the radiation beam. To aid illustration the cross sections are shown on a pair of perpendicular axes 82, 84. The beam in cross section is circular, rotationally symmetric and is perpendicular the optical axis OA.

Referring to FIG. 15a, a cross section 86 of a radiation beam as previously described having a uniform polarisation, for example the initial polarisation of an embodiment of the present invention, has a region of high radiation intensity 88 at a centre of the cross section 86.

Referring to FIG. 15b, a cross section 90 of a radiation beam having a tangential, non-uniform polarisation, produced for example by the half wave plate 54, the sub-wavelength grating 56, or the liquid crystal cell 72 of previous embodiments, has a region of low radiation intensity 92 at the centre of the cross section 90. This low intensity region 92 is surrounded by an annular region of high radiation intensity 94. This region of low radiation intensity 92 is due to an introduction of a phase singularity with one complete rotation of the radiation beam about the optical axis OA. Use of a tangentially polarised radiation beam having this phase singularity in the optical system of the present invention will result in aberrations of a focal spot produced upon focusing the radiation beam.

FIG. 15c shows a cross section 96 of a radiation beam having a tangential, non-uniform polarisation with the phase singularity removed. At the centre of the cross section 96 there is a region of high radiation intensity 98 which is similar to the region of high radiation intensity 88 of the cross section of the uniformly polarised radiation beam of FIG. 15a. In order to remove the phase singularity a phase modification is introduced into the radiation beam. The following expression represents the radiation beam with the introduced phase modification:
\vec{E}=E₀(cos(φ)ŷ+i sin(φ)\hat{x}.e^{iφ} (2)
wherein \hat{x} is a unit vector along the first axis 82, ŷ is a unit vector along the perpendicular second axis and φ is an angular polar coordinate.

FIG. 16 shows schematically a phase modification element in accordance with an embodiment of the present invention. The phase modification element is arranged to introduce the phase modification into the radiation beam having the phase singularity. The phase modification element in this embodiment is a phase plate 99 which adds the phase factor e^{iφ} to the radiation beam to remove the phase singularity. The phase plate 99 is circular and is arranged centrally on the optical axis OA. The phase plate 99 has a radial thickness in a direction parallel the optical axis OA. The radial thickness increases at a constant rate rotationally about the optical axis OA from a minimum thickness 101 to a maximum thickness 104. The minimum thickness 101 and the maximum thickness 104 correspond to a minimum and a maximum optical path length, respectively, of the radiation beam. The minimum thickness 101 and the maximum thickness 104 are connected by a radial step having a height h in a direction parallel the optical axis OA. The height h is determined such that an optical path difference between the minimum optical path length and the maximum optical path length is one wavelength of the radiation beam, in this example preferably approximately 256 nm. This corresponds to one phase cycle of the radiation beam, i.e. a 2π phase step of the radiation beam.

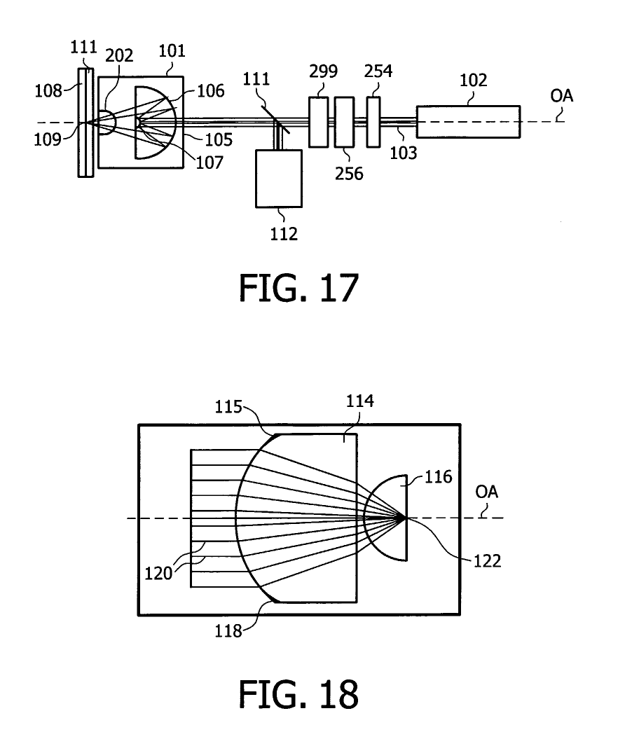

FIG. 17 shows schematically an optical scanning device for scanning an optical record carrier in accordance with the present invention. The optical scanning device includes an embodiment of the optical system of the present invention. Elements and systems of this optical scanning device are similar to elements and systems described earlier in accordance with embodiments of the present invention. For such elements or systems the relevant reference numerals are incremented by 200 and used herein; corresponding previous descriptions of such elements or systems should be taken to apply here also.

Along an optical axis OA is arranged a radiation beam source 102 which produces a radiation beam 103 having a wavelength of preferably approximately 256 nm and having a circular, uniform polarisation. In this example the radiation beam source 102 is a laser. A polarising system changes the circular polarisation to a substantially tangential, non-uniform polarisation. The polarising system comprises a half-wave plate 254 similar to that described using FIG. 8 which changes the circular polarisation of the radiation beam 103 to an intermediate polarisation comprising polarisation components with an approximately similar distribution to the tangential polarisation components of a tangentially polarised radiation beam. The polarising system further comprises a sub-wavelength grating 256 similar to that described using FIG. 9 which changes the intermediate polarisation to a substantially tangential, non-uniform polarisation. A phase modification element is a phase plate 299 similar to that described using FIG. 16 which adds a phase factor to the tangentially polarised radiation beam in order to remove a phase singularity of the radiation beam. A focusing system 105 comprises a Burried Schwarzschild Objective (BSO) lens 106 which makes use of a catadioptric design and contains an aspherical mirror 107. The BSO lens 106 is formed of quartz and in this instance has an NA of approximately 0.65. The focusing system also comprises an optical lens 202 similar to that described using FIG. 1. The optical lens in this embodiment is a birefringent half-ball lens. The focusing system 105 focuses the tangentially polarised radiation beam to a focal spot 109 on an information layer 108 of an optical record carrier, for example an optical disc. The complete rotation about the optical axis OA of the tangential polarisation of the radiation beam corresponds to the circular shape of the optical lens 202 about the optical axis OA. This ensures that component rays of the tangentially polarised radiation beam produce only o-rays in this case and not e-rays, as described earlier. Thus the focal spot 109 does not suffer from aberrations due to the birefringence of the optical lens 202 and is of a high quality. Following focusing of the radiation beam onto the information layer 108 of the optical disc, the radiation beam is reflected back along the optical axis OA and is reflected by a selective mirror 111 to a detection and tracking system 112. The detection and tracking system 112 receives the reflected radiation beam and interprets data of the information layer 108 carried by the reflected radiation beam. Additionally the detection and tracking system 112 identifies any alignment errors of the focal spot 109 with a track of the information layer 108.

FIG. 18 shows schematically an operation of optical elements according to a different embodiment of the optical system of the present invention. A birefringent objective lens 114 and a birefringent half-ball lens 116, similar to the birefringent half-ball lens of the previous embodiment, are arranged along an optical axis OA and form a focusing system of an optical scanning device for scanning an optical record carrier for example, an optical disc. The birefringent objective lens 114 is formed of sapphire (Al₂O₃), is rotationally symmetric about the optical axis OA and has a spherical curved face 115. A rate of curvature of the curved face 115 is of a sufficiently low value to obtain an acceptable tolerance of a manufacturing quality. The curved face 115 is covered with an aspherical layer formed of silicon rubber 118 which has a high refractive index of approximately 1.513. The birefringent objective lens 114 has a NA of approximately 1.1 and an entrance pupil diameter of approximately 1.6 mm. The radiation beam having a substantially tangential polarisation comprises a plurality of component rays 120 travelling along the optical axis OA which are focused by the birefringent objective lens 114 and the birefringent half-ball lens 116 to a focal spot 122. The focal spot 122 is similarly of a high quality as for the previous embodiment as the component rays 120 of the tangentially polarised radiation beam produce only o-rays in the birefringent half-ball lens 116. A distance along the optical axis OA between the optical lens 116, and a substrate layer (not shown) of the optical disc, is determined to be at most approximately one wavelength of the radiation beam, in this example approximately 256 nm.

If the birefringent objective lens 114 was alternatively formed of quartz, the objective lens would have a lower NA of approximately 0.9 and would not have a sufficiently high NA to be of use in the optical scanning device of this embodiment.

Elements and embodiments of the present invention described with the aid of FIGS. 7-10 and FIGS. 15-18 are arranged to function with the non-uniform polarisation of the radiation beam being a substantially tangential polarisation. In further embodiments of the present invention the elements and embodiments described with the aid of FIGS. 7-10 and FIGS. 15-18 are differently and suitably arranged so as to function with the non-uniform polarisation of the radiation beam being a substantially radial polarisation. The above embodiments are understood to be illustrative examples of the invention. Further embodiments of the invention are envisaged.

It is further envisaged that elements of the optical system of the present invention may be formed of alternative materials. For example, the birefringent objective lens and the birefringent half-ball lens may be formed of a different birefringent material having a higher refractive index than sapphire.

Additionally it is envisaged that the optical system may comprise a different polarisation control system for producing a non-uniformly polarised radiation beam, having for example, a tangential polarisation or a radial polarisation.

Furthermore it is envisaged that liquid crystal elements of the array of liquid crystal elements of one embodiment may have different axial and/or radial orientations in order to change a polarisation of the radiation beam.

The phase plate described for an embodiment of the present invention may alternatively be a different phase modification element for introducing a phase modification into a radiation beam.

Focusing systems of embodiments of the present invention comprise optical elements including one or more of a birefringent objective lens, a birefringent half-ball lens and a BSO lens. It is envisaged that alternative optical elements may be included in such a focusing system of an optical system according to the present invention.

In the above-described embodiments, elements of the optical system of embodiments of the present invention are designed to function correctly for a DUV radiation beam having a wavelength of between 200 nm and 300 nm. It however, envisaged that the invention can be applied to any optical system in which a birefringent element, in particular a lens element, has a non-planar refractive surface through which a radiation beam passes.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An optical scanning device for scanning an optical record carrier, wherein said optical scanning device comprises an optical system comprising an optical element arranged on an optical axis in the path of a radiation beam, the optical element (2; 116; 202) comprising a birefringent material, the optical element having a non-planar face (4) through which the radiation beam passes, wherein the optical system comprises a polarisation control system for controlling polarisation of the radiation beam such that the radiation beam has a polarisation which is non-uniform across a cross section (21; 24) taken perpendicular to the optical axis, the non-uniform polarisation having a distribution corresponding with a shape of the said non-planar face.

2. An optical scanning device according to claim 1, wherein, in a plurality of sectors (22) of the said cross section, the polarisation of the beam has a substantially tangential polarisation, which is aligned in a different direction in at least some of said sectors (22).

3. An optical scanning device according to claim 1, wherein, in a plurality of sectors (26) of the said cross section, the polarisation of the beam has a substantially radial polarisation, which is aligned in a different direction in at least some of said sectors (26).

4. An optical scanning device according to claim 2, wherein the shape of the said non-planar face is rotationally symmetric about the optical axis (OA).

5. An optical scanning device according to claim 2, wherein the optical system comprises an optic axis (AB) which is substantially parallel the optical axis (OA).

6. An optical scanning device according to claim 3, wherein the polarisation control system comprises a first polarising element (54; 254) comprising a plurality of different sections (55), wherein each section is arranged to differently modify a polarisation of the radiation beam.

7. An optical scanning device according to claim 4, wherein the first polarising element comprises at least four sections arranged in sectors about said optical axis.

8. An optical scanning device according to claim 5, wherein the polarisation control system comprises an array of liquid crystal elements, wherein the liquid crystal elements have a configuration of different radial and/or axial orientations.

9. An optical scanning device according to claim 5, in which the polarisation control system comprises a polarising system arranged to change an initial, substantially uniform polarisation of the radiation beam to the said non-uniform polarisation.

10. An optical scanning device according to claim 7, wherein the initial polarisation is a linear polarisation.

11. An optical scanning device according to claim 7, wherein the initial polarisation is a circular polarisation and the polarisation control system comprises:
a first polarising element (54; 254) arranged to change said circular polarisation to an intermediate polarisation, and
a second polarising element (56; 256) arranged to change said intermediate polarisation to said non-uniform polarisation.

12. An optical scanning device according to claim 9, wherein the second polarising element is a grating.

13. An optical scanning device according to claim 11, wherein the optical system comprises a phase modification element (99; 299), said phase modification element being arranged to introduce a phase modification into the radiation beam.

14. An optical scanning device according to claim 12, wherein the radiation beam is of substantially one wavelength and the phase modification is substantially one phase cycle of the wavelength.

15. An optical scanning device according to claim 13, wherein the radiation beam is an ultraviolet radiation beam.

16. An optical scanning device according to claim 14, wherein the optical element is a lens element.

17. (canceled)
